(19) United States
(12) Patent Application Publication
(10) Pub. No.: US 2009/0304956 A1
(43) Pub. Date: Dec. 10, 2009

(54) Use of Polysulphide- Containing Two- Component Adhesives for the Production of Windows

(75) Inventors: Manfred Probster, Nussloch (DE); Stefan Grimm, Schwetzingen (DE); Mario Lang, Meinhardt (DE)

Correspondence Address: H.B. FULLER COMPANY;Patent Department, 1200 WILLOW LAKE BLVD., P.O. BOX 64683, ST. PAUL, MN, 55164-0683, US

(73) Assignee: H.B. Fuller Licensing & Financing, Inc., St. Paul, MN (US)

(21) Appl. No.: 12/162,203

(22) PCT Filed: Dec. 18, 2006
(86) PCT No.: PCT/EP06/12163

§ 371 Date: May 8, 2009

(30) Foreign Application Priority Data
Jan. 26, 2006 (DE) 10 2006 003 935.1

(51) Int. Cl. C08G 59/32; C09J 163/00; E06B 3/00; C08L 81/04; C08K 5/10; C08K 5/103

(52) U.S. Cl. 428/34; 156/109; 524/609; 524/296; 524/287; 524/291

(57) ABSTRACT

A polysulphide-containing two-component adhesive/sealant consists of a binder component and a curing agent component, and is suitable for use as the secondary seal in the edge region of the insulating glass and/or for bonding the insulating glass unit in the frame or window sash of a window unit in a friction locked manner according to the process of rebate base bonding or back bedding.

The present invention relates to two-component adhesives/sealants based on epoxy-functional polysulphide polymers and aminofunctional liquid rubbers and their use for secondary sealing in the peripheral bond of the insulating glass and/or for bonding the insulating glass unit to the window sash or window frame in a friction locked manner.

### BACKGROUND OF THE INVENTION

One-component or multi-component compositions based on polysulphide polymers and/or polymer captan polymers have long been used successfully in the building and construction industry, in the aircraft and automotive industries, in shipbuilding, and on a large scale for the production of insulating glass. One of the main reasons for the very high market share of insulating glass adhesives/sealants based on polysulphide polymers or polymer captans is that these polymers are characterised by a high ozone resistance and also exhibit very good resistance to many solvents and chemicals. Furthermore, they possess a very high long-term resistance to atmospheric exposure and exhibit very low permeability for gases. On this subject, see, for example, A. Damusis, “Sealants”, New York (1967), pages 182-184; E. Dachselt “Thioplaste” Leipzig (1971), pages 50-56 or H. Lücke “Aliphatische Polysulfide”. Heidelberg, (1992) pages 111-114.

Adhesives/sealants for the production of insulating glass bonds are usually formulated as two-component systems in which the two components are only united immediately before application, then mixed and applied.

With a two-component material of this kind, one component usually contains the binder—in this case a liquid polysulphide polymer or liquid polymer captan polymer. This component is usually referred to as component “A”. The second component contains a cross-linking agent, curing agent or oxidising agent and is usually referred to as component “B”. In addition, both components as a rule contain plasticisers, fillers, and optionally pigments or dyes. Furthermore, component A may also contain adhesion-promoting substances, and antioxidant agents, and component B may also contain accelerators.

In the standard commercially available insulating glass arrangements, rigid spacers ensure the desired distance between the panes of glass. In the most common embodiment, the spacer consists of a hollow aluminium or sheet steel profile. It is disposed near the edges of the glass panes in such a way that the spacer, together with the edge regions of the glass pane, forms an outwardly facing channel to accommodate sealants and adhesives. Usually, the side of the spacer facing the gap between the glass panes has small apertures, and the cavity of the spacer serves to receive a desiccant to absorb the moisture and any solvent possibly remaining in the air or gas gap between the panes. This prevents moisture from condensing on the inside of the insulating glass panes when the ambient temperature is low. In high-quality insulating glass systems, there is a sealant with a high water vapour barrier effect between the surfaces of the spacer facing the glass panes and the glass surface. Formulations based on polyisobutylene and/or butyl rubber are used for this purpose as a rule (primary seal). The channel formed by the outwardly facing surface of the spacer and the edge regions of the glass panes is usually filled with a two-component adhesive/sealant, which produces a sufficiently strong bond between the insulating glass arrangement. This adhesive/sealant must adhere well to the panes and also be elastic enough to withstand the expansion and contraction movements of the glass panes under changing climatic conditions (secondary seal).

In many cases, an insulating glass unit produced in this way is fitted into the window sash mechanically using glazing blocks and is then sealed against penetrating water with an elastic sealant in the transition area between the rebate and the glass panes. In more recent times, the insulating glass modules have also been bonded to the window sash or window frame.

When gluing multi-pane insulating glass into the frame, it is possible to distinguish between 3 basic cases:
1. bonding the insulating glass unit to the frame in the base of the rebate,
2. bonding the insulating glass unit to the frame at the side of the glass without any contact with the secondary seal of the edge region of the insulating glass unit (known as back bedding), and
3. mixed forms of 1 and 2.

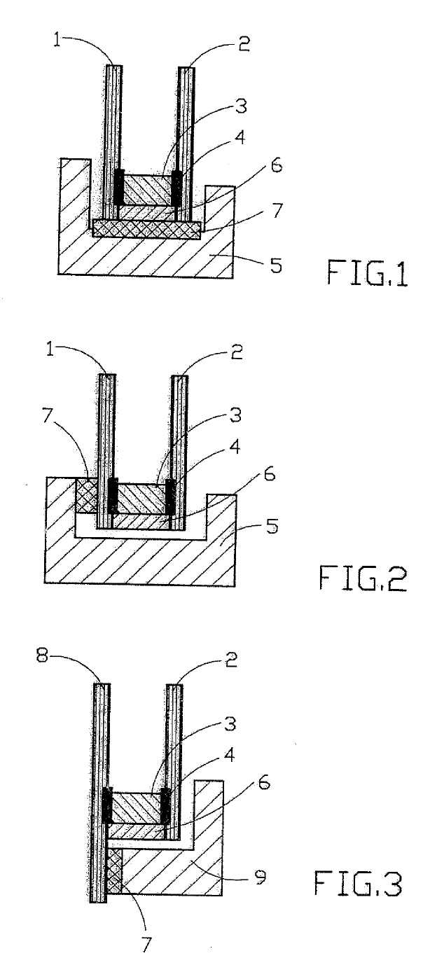

FIG. 1 shows rebate base bonding.

FIG. 2 illustrates back bedding, in which the two panes (1) and (2) of the insulating glass module have the same dimensions, and the adhesive layer (7) is located between one of the parallel inner surfaces of the rebate and the edge region of the outer surface of the outwardly facing pane.

FIG. 3 shows back bedding, in which the outwardly facing pane of the insulating glass module is bigger than the pane facing inwards. The adhesive layer is located between the overhanging edge region of the outer pane and the part of the frame parallel to the outer pane.

When the insulating glass unit is glued into the base of the rebate of the frame, the adhesive layer fills the peripheral gap between the edge regions of the insulating glass and the rebate (5) of the profile frame enclosing the insulating glass. Here, the adhesive (7) serves to bond the frame to the insulating glass module in a friction locked manner and at the same time ensures good support for the individual panes of the insulating glass vis-à-vis the profile frame. In this case, the peripheral gap between the insulating glass module and the base of the rebate is usually filled with the adhesive to a depth corresponding to the thickness of the insulating glass, so that the width of the resulting strip of adhesive corresponds to the total thickness of the insulating glass. In this context, the adhesive must be sufficiently elastic to absorb stresses resulting from different coefficients of thermal expansion between the bonded materials without impairing the adhesive bond. Since the adhesive (7) is in direct contact with the secondary seal (6), it must be ensured that the adhesive (7) and the secondary seal (6) are mutually compatible or preferably identical. FIG. 1 illustrates this case in a vertical section through the window module.

In the case of back bedding, the adhesive layer (7) is located in the gap between the outer surface of the outer pane (1) of the insulating glass unit and the lateral inner surface of the rebate (5) of the frame in order to bond the frame to the insulating glass module in a friction locked manner. This case of back bedding is illustrated in FIG. 2 in the vertical section through the module. In this case, there is no direct contact between the adhesive (7) and the secondary seal (6).

In a further embodiment, the outer pane (8) of the insulating glass unit is bigger than the inner pane and extends in the edge region beyond the line formed by the edge of the inner pane and the secondary seal (6). Here the adhesive bond is achieved by the adhesive layer between the inside of the overhanging edge of the outer pane of the insulating glass module and the correspondingly shaped part of the frame profile. This case is illustrated in FIG. 3.

In all the above-mentioned bonding processes, adhesives with a very wide range of chemical bases are used as 2-component products or 1-component hot melts, such as silicones, polyurethanes, acrylates and also adhesive strips. The secondary seal for the edge region of the insulating glass can likewise be achieved with sealants with a wide range of chemical bases, examples being silicones, polysulphides, polyurethanes, and polyolefin hot melts. When windows are manufactured in accordance with the above-mentioned bonding processes, if adhesives with different chemical bases and compositions come together, there may be incompatibility, such as the migration of plasticizers, which may lead to the failure of the bond or of the joint in the edge region of the insulating glass. If the joint in the edge region of the insulating glass and the bonding are performed with silicone sealants, the gas-filled multi-pane insulating glass which is customary today can only be prepared with considerable additional effort (primary seal of large dimensions and rear of the spacer covered to a great height with the silicone sealant).

According to the state of the art today, the joint in the edge region of gas-filled multi-pane insulating glass takes the form of an inner seal (4) based on polyisobutylene between the glass (1) and (2) and the spacer (3) and an outer seal (secondary seal (6)) for bonding the spacer (3) to the glass (panes (1) and (2). In a preferred embodiment, the back of the spacer (3) must in this case be sufficiently covered with sealant (6) in order to ensure the stability and tightness of the system against penetrating moisture and escaping argon. The sealants used for the secondary seal (6) in this case are based on polyurethane, polysulphide, silicone polymers or polyolefins.

Special spacer profiles (“sparspacers”), however, provide that the back of the spacer profile is no longer completely covered with sealant, but that only a narrow application of adhesive is used as a secondary seal in a defined narrow strip between the glass and the spacer. Spacer profiles of this kind are proposed in WO2004/038155 A1, for example. The strength and durability of the conventional polysulphide adhesives/sealants for the joint in the edge region of the insulating glass is not sufficient for this application.

As already stated above, the adhesives/sealants for use in the field of insulating glass are also characterized in particular by the fact that they exhibit very high long-term resistance to atmospheric exposure and have a very low permeability for gases and moisture. It is therefore desirable to have adhesives/sealants based on polysulphide polymers available also for bonding multi-pane insulating glass modules into the frame. The inventors have therefore set themselves the problem of providing such adhesives/sealants based on polysulphide polymers which are suitable for bonding insulating glass modules to the frame.

### BRIEF SUMMARY OF THE INVENTION

The solution to the problem in accordance with the invention can be gathered from the claims. It consists substantially in providing a tvo-component adhesive/sealant consisting of a binder component and a curing agent component, wherein

A) the binder component contains
5 to 50% by weight of epoxidised alkylene polysulphide,
5 to 25% by weight of at least one plasticizer,
30 to 60% by weight of fillers,
0.5 to 4% by weight of an adhesion promoter, and

B) the curing agent component contains
20 to 50% by weicrht of at least one plasticizer,
0.1 to 40% by weight of at least one amine-terminated liquid rubber,
1 to 5% by weight of an accelerator,
20 to 60% by weight of fillers,
1 to 10% by weight of carbon black,
   and the sum of the constituents of component A or B respectively each totals 100%, wherein the components A and B are to be mixed at a ratio of 2:1 to 1:2, preferably at a ratio of 1:1, for curing.

A further subject of the invention relates to the use of the above-mentioned adhesive/sealant to provide a secondary seal in the edge region of the insulating glass and/or for bonding the insulating glass unit to the frame in the base of the rebate in a friction locked manner and/or for bonding the lateral edge region of the insulating glass panes to the parallel inner surfaces of the rebate of the window frame or window sash in a back bedding application.

### DETAILED DESCRIPTION OF THE INVENTION

The epoxidised alkylene polysulphide of the binder component can be prepared by, for example, reacting polysulphides with an average molecular weight of about 168 to 40,000 and having thiol terminal groups with epichlorohydrin in the presence of an aqueous alkali lye, the epichlorohydrin being prepared and the polysulphide having thiol terminal groups being added, after which the reaction mixture is processed. Sulphides having thiol terminal groups can be prepared by, for example, reacting sodium polysulphide with dichloroethyl formal to a dithiol of formula

HS(CH₂CH₂OCH₂OCH₂CH₂SS)nCH₂CH₂OCH₂OCH₂CH₂SH

and optionally converted in a subsequent step by reductive S—S cleavage into liquid polymers with a defined molecular weight range. A method of this kind for the preparation of epoxidised alkylene polysulphides is disclosed in, for example, WO 03/099908 A1. These epoxidised alkylene polysulphides are referred to as “aliphatic epoxidised alkylene polysulphides”. Alternatively, a polysulphide polymer containing mercaptan terminal groups can be reacted with an excess of an aromatic epoxide, such as the diglycidyl ether of bisphenol A. In the latter case, one arrives at the “aromatic epoxidised alkylene polysulphides”. For the adhesives/sealants of the invention and in particular for their use in bonding the insulating glass unit to a window frame or window sash in a friction locked manner, the aromatic epoxidised alkylene polysulphides are particularly suitable for the binder component, i.e. component A, of a two-component adhesive/sealant. It is, however, also possible to use mixtures of aromatic and aliphatic epoxidised alkylene polysulphides.

The curing agent component (also referred to as component B) contains, as the main constituent, an amine-terminated liquid rubber, preferably based on aminoterminated butadiene-acrylonitrile copolymers.

The reactive constituents of the binder component and the curing agent component are conveniently matched in such a way that for the use of the two-component adhesive/sealant system, simple volume ratios and comparable viscosity ranges of the components are used. The volume ratios of the binder component A to the curing agent component B are preferably from 2:1 to 1:2, a ratio of 1:1 being particularly preferred.

Examples of suitable plasticizers in the binder and/or curing agent component are phthalate plasticizers, which are known per se, based on phthalic acid alkyl or aryl esters, provided that their volatile constituents are so low that these plasticizers do not cause “fogging” and that the phthalate plasticizers are also compatible with the binder system, i.e. that they do not tend to exudation. Specific examples here are butyl benzyl phthalate or 7-(2,6,6,8-tetramethyl-4-oxa-3-oxononyl)-benzyl phthalate, also known by the trade name “SANTICIZER 278” (Solutia). For both components A and B, however, it is very particularly preferred to use benzoate plasticizers. Examples of suitable benzoate plasticizers are benzoic acid esters of ethylene glycol, diethylene glycol, triethylene glycol, tetraethylene glycol, propylene glycol, dipropylene glycol, tripropylene glycol, tetrapropylene glycol, 2,2,4-trimethyl-1,3-pentane diol, hydroxypivalic acid neopentyl glycol ester or mixtures thereof.

Possible fillers that can be used may, for example, be coated and/or uncoated precipitated or ground chalks (calcium carbonates, calcium-magnesium carbonates), aluminium silicates, magnesium silicates, clay, barium sulphate or mixtures thereof. It is also possible to use mixtures of the above-mentioned fillers. In addition, thixotroping agents, such as bentonites (montmorillointe), fumed silicic acids, fibrous thixotroping agents or hydrogenated castor oils, may be used. Apart from that, either the A and/or the B component may contain pigments such as titanium dioxide, carbon black or inorganic dye pigments. The fillers are present in the binder component in an amount of 20 to 70% by weight, preferably between 30 and 60% by weight and particularly preferably 30 to 50% by weight. As a rule, the curing agent component contains 10 to 60% by weight of fillers, preferably between 20 and 50% by weight. Pigments are used in amounts of between 0.1 and 5% by weight; in the case of carbon black, up to 10% by weight may also be used.

Organofunctional silanes, such as mercaptofunctional, aminofunctional and in particular epoxyfunctional silanes, may preferably be used as adhesion promoters. Examples of mercaptofunctional silanes are 3-mercaptopropyl trimethoxysilane or 3-mercaptopropyl triethoxysilane or their alkyl dimethoxy or alkyl diethoxy analogues. As examples of aminofunctional silanes, 3-aminopropyl alkoxysilanes, 2′-aminoethyl-3-aminopropyl alkoxysilanes may be mentioned. Epoxyfunctional silanes may be selected from a large number of compounds. By way of example, the following may be mentioned: 3-glycidyl oxymethyl trimethoxysilane, 3-glycidyl oxymethyl triethoxysilane, 3-glycidoxymethyl tripropoxysilane, 3-glycidoxymethyl tributoxysilane, 2-glycidoxyethyl trimethoxysilane, 2-glycidoxyethyl triethoxysilane, 2-glycidoxyethyl tripropoxysilane, 2-glycidoxyethyl tributoxysilane, 2-glycidoxyethyl trimethoxysilane, 1-glycidoxyethyl triethoxysilane, 1-glycidoxyethyl tripropoxysilane, 1-glycidoxyethyl tributoxysilane, 3-glycidoxypropyl trimethoxysilane, 3-glycidoxypropyl triethoxysilane, 3-glycidoxypropyl tripropoxysilane, 3-glycidoxypropyl tributoxysilane, 2-glycidoxypropyl trimethoxysilane, 2-glycidoxypropyl triethoxysilane, 2-glycidoxypropyl tripropoxysilane, 2-glycidoxypropyl tributoxysilane, 1-glycidoxypropyl trimethoxysilane, 1-glycidoxypropyl triethoxysilane, 1-glycidoxypropyl tripropoxysilane, 1-glycidoxypropyl tributoxysilane, 3-glycidoxybutyl trim ethoxysilane, 4-glycidoxybutyl triethoxysilane, 4-glycidoxybutyl tripropoxysilane, 4-glycidoxybutyl tributoxysilane, 4-glycidoxybutyl trimethoxysilane, 3-glycidoxybutyl triethoxysilane, 3-glycidoxybutyl tripropoxysilane, 3-alpropoxybutyl tributoxysilane, 4-glycidoxybutyl trimethoxysilane, 4-glycidoxybutyl triethoxysilane, 4-glycidoxybutyl tripropoxysilane, 1-glycidoxybutyl trimethoxysilane, 1-glycidoxybutyl triethoxysilane, 1-glycidoxybutyl tripropoxysilane, 1-glycidoxybutyl tributoxysilane, (3,4-epoxycyclohexyl)methyl trimethoxysilane, (3,4-epoxycyclohexyl)methyl trimethoxysilane, (3,4-epoxycyclohexyl)methyl tripropoxysilane, (3,4-epoxycyclohexyl)methyl tributoxysilane, (3,4-epoxycyclohexyl)ethyl trimethoxysilane, (3,4-epoxycyclohexyl)ethyl triethoxysilane, (3,4-epoxycyclohexyl)ethyl tripropoxysilane, (3,4-epoxycyclohexyl)ethyl tributoxysilane, (3,4-epoxycyclohexyl)propyl trimethoxysilane, (3,4-epoxycyclohexyl)propyl triethoxysilane, (3,4-epoxycyclohexyl)propyl tripropoxysilane, (3,4-epoxycyclohexyl)propyl tributoxysilane, (3,4-epoxycyclohexyl)butyl trimethoxysilane, (3,4-epoxycyclohexyl)butyl triethoxysilane, (3,4-epoxycyclohexyl)butyl tripropoxysilane, (3,4-epoxycyclohexyl)butyl tributoxysilane. Instead of or together with the above-mentioned trialkoxysilanes, it is also possible to use the corresponding alkyl dialkoxysilanes, 3-glycidoxypropyl trimethoxysilane, 3-glycidoxypropyl triethoxysilane and the following cyclohexyl derivatives are particularly preferred: 2-(3,4-epoxycyclohexyl)ethyl triethoxysilane, 4-(methyl diethoxysilyl)-1,2-epoxy cyclohexane, 3-(3,4-epoxycyclohexyl)propyl tri-(isobutoxy)silane, optionally mixed with the above-mentioned glycidoxypropyl derivatives. The adhesion promoters are preferably used in the binder component in amounts between 0.1 and 10% by weight, preferably between 0.5 and 4% by weight, especially preferably between 0.5 and 2% by weight. Aminofunctional adhesion promoters may, however, also be used in the above-mentioned amounts in the curing agent component.

The amine-terminated liquid rubbers used are aminoterminated butadiene-acrylo-nitrile copolymers (ATBN), which are available from Noveon, for example, under the trade name “HYCAR”. They have molecular weights between 2,000 and 5,000 and acrylonitrile contents between 10% and 30%. Specific examples are HYCAR ATBN 1300 X 21, 1300 X 16, 1300 X 42, 1300 X 45 or 1300 X 35. Molecular weight ranges between 3,000 and 5,000 and acrylonitrile contents between 15 and 25% are preferred.

The catalysts or accelerators are mainly selected from the group of imidazoles, Mannich bases, guanidines, monofunctional mercaptans or mixtures thereof. Examples of imidazoles that can be used are 2-ethyl-2-methyl imidazole, N-butyl imidazole, benzimidazole and N—C₁ to C₁₂ alkyl imidazoles or N-aryl imidazoles. Examples of Mannich bases are condensation products from diamines or polyamines with active hydrogen components, such as aldehydes, ketones, esters or aromatics (e.g. phenols) or heteroaromatics, especially tris-2,4,6-(dimethyl amino)phenol, bis(dimethyl aminomethyl)phenol or mixtures thereof. In addition, guanidines, substituted guanidines, substituted ureas, melamine resins, guanamine derivatives, cyclic tertiary amines, aromatic amines and/or mixtures thereof may be used. In this context, the catalysts may equally well participate stoichiometrically in the curing reaction, but they may also be catalytically effective. Examples of substituted guanidines are methyl guanidine, dimethyl guanidine, trimethyl guanidine, tetramethyl guanidine, methyl isobiguanidine, dimethyl isobiguanidine, tetramethyl isobiguanidine, hexamethyl isobiguanidine, heptamethyl isobiguanidine and most particularly cyanoguanidine (dicyandiamide). Representatives of suitable guanamine derivatives that can be mentioned are alkylated benzoguanamine resins, benzoguanainine resins or methoximethyl ethoxymethyl benzoguanamine. In principle, all liquid alkyl or aryl monomer capto compounds can be used as monofunctional mercaptans. In order to avoid unnecessary annoyance caused by bad odours, alkyl mercaptans should only be used as of the C₄ compounds. The accelerators or catalysts are used in amounts of 1 to 10% by weight, preferably between 2 and 5% by weight, or up to 3% by weight.

In addition to the amine-terminated liquid rubber, the curing agent component may also contain 0 to 10% by weight, preferably 2 to 5% by weight, of an aliphatic or cycloaliphatic polyamine.

Examples here are ethylene diamine, 1,3-propylene diamine, 1,4-diaminobutane, 1,3-pentane diamine, methyl pentane diamine, hexamethylene diamine, trimethyl hexamethylene diamine, 2-(2-aminomethoxy)ethanol, 2-methypentamethylene diamine, C₁₁-neopentane diamine, diaminodipropyl methylamine, 1,12-diaminododecane or polyoxyalkylene diamines, such as polyoxyethylene diamines, for example, polyoxypropylene diamines or bis-(di-aminopropyl)-polytetrahydrofuran. The polyoxyalkylene diamines are also known as “JEFFAMINES” (Huntsman trade name). The molecular weight of the Jeffamines to be used is between 200 and 4,000, preferably between 400 and 2,000. The amino component may in addition contain cyclic diamines or heterocyclic diamines, such as, for example, 1,4-cyclohexane diamine, 4,4′-diamino-dicyclohexyl methane, piperazine, cyclohexane-bis-(methylamine), isophorone diamine, dimethyl piperazine, dipiperidyl propane, dimer diamines (amines prepared from dimer fatty acids), cyclohexane-bis-(methylamine), isophorone diamine, dipiperidyl propane, norbornan diamine or m-xylylene diamine. Mixtures of the above-mentioned amines or optionally their adducts of low-molecular-weight epoxides can also be used, as are conventionally available for the production of solvent-free epoxy coatings.

The invention will be explained in more detail in the following exemplary embodiments, where the choice of the examples is not intended to imply any restriction of the scope of the subject matter of the invention; they are merely intended to illustrate individual embodiments and advantageous effects of the invention in the form of models. All the quantities given in the following examples are shown in parts by weight or percentages by weight, unless stated otherwise.

### EXAMPLES

The binder component (A) and the curing agent component (B) were each prepared separately by mixing the individual constituents in a planetary-type mixer capable of evacuation.

### Example 1

Component A

| | |
|---|---|
| Aromatic thioplast EPS resin EPS70 | 13.00 |
| Benzoic acid ester Benzoflex 988 | 16.00 |
| Chalk, precipitated, coated | 15.00 |
| Chalk, ground, coated | 25.00 |
| Barium sulphate | 29.00 |
| Epoxysilane | 2.00 |

Component B

| | |
|---|---|
| Amine-terminated NBR HYCAR 1300X 16 ATBN | 36.00 |
| Benzoic acid ester Benzoflex 988 | 10.00 |
| Water | 1.40 |
| Carbon black | 3.00 |
| Chalk ground, coated | 30.60 |
| Barium sulphate | 16.00 |
| Hydrogenated castor oil | 2.00 |

### Example 2

Component A

| | |
|---|---|
| Aromatic thioplast EPS resin EPS350 | 28.00 |
| Benzoic acid ester Benzoflex 988 | 10.00 |
| Chalk, precipitated, coated | 28.00 |
| Chalk ground, coated | 12.00 |
| Barium sulphate | 20.00 |
| Epoxysilane | 2.00 |

Component B

| | |
|---|---|
| Amine-terminated NBR HYCAR 1300X 16 ATBN | 28.00 |
| Cycloaliphatic polyamine Aradur 2964 | 5.00 |
| Benzoic acid ester Benzoflex 988 | 8.00 |
| Water | 1.00 |
| Carbon black | 4.00 |
| Chalk, ground, coated | 40.00 |
| Barium sulphate | 9.00 |
| Hydrogenated castor oil | 1.00 |
| Aminomethyl phenol Ancamin K54 | 2.00 |

The compositions in accordance with the invention are characterized by the following properties:

Depending on the formulation, the 2-component adhesive/sealant can be used as a secondary seal in the joint in the edge region of the insulating glass with conventional spacers and also with “sparspacers”, and is also suitable for bonding the insulating glass unit to the frame.

Specifically when the amounts applied are small, the adhesive must be metered and mixed well because of the mixing ratio 1:1 (volume). It possesses very good resistance to attacking agents, specifically also aqueous ones, and has very low water absorption in weathering trials.

It has high strength values, with sufficient elasticity, even after UV ageing, and no compatibility problems when the system is used as the secondary seal and as the rebate base seal at the same time.

It is characterized by good resistance to water vapour and argon diffusion.

### LIST OF REFERENCE NUMERALS

1 Outer pane of the insulating glass module in the case of panes with the same dimensions
2 Inner pane of the insulating glass module
3 Spacer
4 Primary seat (water vapour and gas barrier) of the insulating glass module
5 Rebate of the window frame or window sash
6 Secondary seal of the insulating glass module
7 Adhesive layer for bonding the insulating glass module to the frame in a friction locked manner
8 Outer pane of the insulating glass module in the case of panes with different dimensions
9 Frame for accommodating the insulating glass module in the case of panes with different dimensions

1. Two-component adhesive/sealant consisting of a binder component and a curing agent component, wherein
A) the binder component contains
5 to 50% by weight of epoxidised alkylene polysulphide,
5 to 25% by weight of at least one plasticizer,
20 to 70% by weight of at least one filler,
0.1 to 10% by weight of an adhesion promoter, and
B) the curing agent component contains
20 to 50% by weight of at least one plasticizer,
0.1 to 40% by weight of at least one amine-terminated liquid rubber,
1 to 10% by weight of an accelerator,
10 to 60% by weight of at least one filler,
up to 10% by weight of carbon black,
and the sum of the constituents of component A or B respectively each totals 100%, wherein the components A and B are to be mixed at a ratio of 2:1 to 1:2.

2. The adhesive/sealant as claimed in claim 1, wherein the plasticizer is a phthalate plasticizer or a benzoate plasticizer.

3. The adhesive/sealant as claimed in claim 2, wherein the plasticizer is a benzoate plasticizer selected from the g oup consisting of benzoic acid esters of ethylene glycol, diethylene glycol, triethylene glycol, tetraethylene glycol, propylene glycol, dipropylene glycol, tripropylene glycol, tetrapropylene glycol, 2,2,4-trimethyl-1,3-pentane diol, hydroxypivalic acid neopentyl glycol esters, and mixtures thereof.

4. The adhesive/sealant as claimed in claim 1, wherein the adhesion promoter is selected from the group consisting of 3-glycidoxypropyl trimethoxysilane, 3-glycidoxypropyl triethoxysilane 2-(3,4-epoxycyclohexyl)ethyl triethoxysilane, 4-(methyl diethoxysilyl)-1,2-epoxycyclohexane, 3-(3,4-epoxycyclohexyl)propyl tri-(isobutoxy)silane, and mixtures thereof.

5. The adhesive/sealant as claimed in claim 1, wherein the amine-terminated liquid rubber is an aminoterminated butadiene-acrylonitrile copolymer (ATBN).

6. The adhesive/sealant as claimed in claim 5, wherein the aminoterminated butadiene-acrylonitrile copolymer (ATBN) has an acrylonitrile content of 10 to 30%.

7. The adhesive/sealant as claimed in claim 5, wherein the aminoterminated butadiene-acrylonitrile copolymer (ATBN) has a molecular weight of 2,000 to 5,000.

8. The adhesive/sealant as claimed in claim 1 wherein the curing agent component B further contains up to 10% by weight of an aliphatic or cycloaliphatic polyamine.

9. The adhesive/sealant as claimed in claim 1, wherein the accelerator in the curing agent component B is selected from the group consisting of imidazoles, Mannich bases, guanidines, monofunctional mercaptans, and mixtures thereof.

10. A method of providing a secondary seal in an edge region of an insulating glass and/or bonding an insulating glass unit to the base of the rebate of a window frame or window sash in a friction locked manner and/or bonding a lateral edge region of insulating glass panes to parallel inner surfaces of the rebate of the window frame or window sash, comprising utilizing the adhesive/sealant of claim 1.

11. The adhesive/sealant as claimed in claim 1, wherein the component A contains 30 to 60% by weight of the fillers.

12. The adhesive/sealant as claimed in claim 1, wherein the component A contains 0.5 to 4% by weight of the adhesion promoter.

13. The adhesive/sealant as claimed in claim 1, wherein the component B contains 1 to 5% by weight of the accelerator.

14. The adhesive/sealant as claimed in claim 1, wherein the component B contains 1 to 10% by weight of carbon black.

15. A multi-pane insulating glass unit, comprising the adhesive/sealant of claim 1.

16. A window unit comprising a multi-pane insulating glass unit and a window sash or window frame, wherein the insulating glass unit is bonded to the window sash or window frame with the adhesive/sealant of claim 1.

17. A method of making a multi-pane insulating glass unite comprising utilizing the adhesive/sealant of claim 1 as a secondary seal.

18. A method of making a window unit, comprising bonding an insulating glass unit to a window sash or winder frame with the adhesive/sealant of claim 1.

19. a multi-pane insulating glass unit prepared by the method of claim 17.

20. A window unit prepared by the method of claim 18.
